(19) United States
(12) Patent Application Publication
(10) Pub. No.: US 2014/0141153 A1
(43) Pub. Date: May 22, 2014

(54) METHOD OF MANUFACTURING CONDUCTIVE PASTE

(71) Applicant: E I DU PONT DE NEMOURS AND COMPANY, Wilmington, DE (US)

(72) Inventor: RYOICHIRO TAKAHASHI, Kanagawa (JP)

(73) Assignee: E I DU PONT DE NEMOURS AND COMPANY, Wilmington, DE (US)

(21) Appl. No.: 13/681,639

(22) Filed: Nov. 20, 2012

(51) Int. Cl. H01B 1/22; B05D 5/12; H01B 1/24

(52) U.S. Cl. CPC H01B 1/22; H01B 1/24; B05D 5/12
USPC 427/58; 252/500

(57) ABSTRACT

A method of manufacturing a conductive paste comprising steps of: (a) preparing 5 to 60 parts by weight of an organic medium comprising, (i) 2 to 20 parts by weight of an organic polymer; and (ii) 3 to 40 parts by weight of a solvent comprising propylene glycol phenyl ether (PPh) and a dibasic ester (DBE) comprising one or more of dimethyl adipate, dimethyl glutarate or dimethyl succinate, wherein dimethyl succinate is not more than 1 wt % based on the weight of DBE, and wherein the mixing ratio of PPh and DBE is determined according to a desired viscosity at a desired shear rate, and (b) dispersing 40 to 95 parts by weight of a conductive powder into the organic medium.

### FIELD OF INVENTION

The present invention relates to a method of manufacturing a conductive paste.

### TECHNICAL BACKGROUND OF THE INVENTION

A conductive paste is widely used to form an electrode in electrical devices.

US20090169724 discloses a conductive paste to make an electrode for membrane touch switch including an electrically conductive powder, phenoxy resin, urethane resin, and an organic solvent which is a mixture of dibasic ester containing 0.2 wt % of dimethyl adipate, 66 wt % of dimethyl glutarate and 33 wt % of dimethyl succinate and the rest of methanol and water; and cyclohexanone or n-methyl pyrolidone.

### BRIEF SUMMARY OF THE INVENTION

An objective is to provide a conductive paste having a desired viscosity at a desired shear rate.

An aspect of the invention relates to a method of manufacturing a conductive paste comprising steps of: (a) preparing 5 to 60 parts by weight of an organic medium comprising, (i) 2 to 20 parts by weight of an organic polymer; and (ii) 3 to 40 parts by weight of a solvent comprising propylene glycol phenyl ether (PPh) and a dibasic ester (DBE) comprising one or more of dimethyl adipate, dimethyl glutarate or dimethyl succinate, wherein dimethyl succinate is not more than 1 wt % based on the weight of DBE, and wherein the mixing ratio of PPh and DBE is determined according to a desired viscosity at a desired shear rate, and (b) dispersing 40 to 95 parts by weight of a conductive powder into the organic medium.

Another aspect of the invention relates to a method of manufacturing an electrode comprises steps of: applying the conductive paste manufactured above onto a substrate; and heating the applied conductive paste on the substrate at 60 to 1000° C.

Another aspect of the invention relates to a method of manufacturing a conductive paste comprising steps of: (a) creating a trend line regarding mixing ratio of two different solvents and viscosity at a desired shear rate in a conductive paste comprising the solvents; (b) determining a desired viscosity in the conductive paste; (c) determining a mixing ratio of the two different solvents based on the trend line and the desired viscosity so that actual viscosity of the paste composition will be around the desired viscosity at the desired shear rate; (d) preparing 5 to 60 parts by weight of an organic medium comprising, (i) 2 to 20 parts by weight of an organic polymer; and (ii) 3 to 40 parts by weight of the solvents; and (e) dispersing 40 to 95 parts by weight of a conductive powder into the organic medium.

Another aspect relates to an electrical device comprising an electrode manufactured with the conductive paste manufactured above.

A conductive paste having a desired viscosity at a desired shear rate can be obtained by the present invention.

### BRIEF DESCRIPTION OF THE DRAWINGS

FIG. 1 is a cross sectional diagram of the electrode formed on a substrate.

FIG. 2 shows the example of “flow curves of viscosity-shear rate”.

FIG. 3 shows the example of trend line of the mixing ratio and viscosity at shear rate 10 (1/s).

### DETAILED DESCRIPTION OF THE INVENTION

The method of manufacturing the conductive paste and components of the conductive paste are explained below. The below description is mainly directed to an embodiment where propylene glycol phenyl ether (PPh) and dibasic ester (DBE) are used as solvent. However, the method can be used for a different set of solvents.

### Conductive Paste Manufacturing

The method of manufacturing a conductive paste comprising steps of, (a) preparing an organic medium comprising, (i) an organic polymer and (ii) a solvent comprising propylene glycol phenyl ether (PPh) and dibasic ester (DBE); and (b) dispersing a conductive powder into the organic medium.

Viscosity and shear rate of the conductive paste need to be controlled depending on a desired pattern of the electrode and/or a method of apply the conductive paste, for example, screen printing, stencil printing, spin coating, blade coating or nozzle discharge.

The viscosity at a desired shear rate of the conductive paste can be controlled by adjusting the mixing ratio of PPh and DBE in the solvent. The mixing ratio of PPh and DBE can be determined in advance as follows.

The viscosity of the conductive paste lowers as the shear rate increases and the rate of decline changes due to the mixing ratio of PPh and DBE as shown in FIG. 2. The flow curves of viscosity associated with the shear rate in FIG. 2 can be drawn by measuring the viscosity of a conductive paste with a viscosity-viscoelasticity measuring instrument known as a rheometer. HAAKE series from Thermo Fisher Scientific Inc. can be used as the rheometer.

In the measurement, the shear rate can be set up in the rheometer to rise from 0.1 to 100 (1/second, 1/s) and then lower from 100 to 0.1 (1/s) for 60 seconds and the viscosity is continuously measured at 25° C. while the shear rate lowers from 100 to 0.1 (1/s). As a result, the flow curves of viscosity-shear rate such as the one in FIG. 2 can be drawn.

The trend line of the mixing ratio of PPh and DBE and the measured viscosity at a desired shear rate is created based on the flow curves in FIG. 2. For example, the correlation line of the mixing ratio on X axis and the viscosity on Y axis at shear rate 10 (1/s) is drawn as shown in FIG. 3. The trend line can be expressed by an equation of “y=36.713x+101.17”. The mixing ratio to obtain a desired viscosity at the shear rate 10 (1/s) can be calculated from the equation. For example, to make the conductive paste with viscosity of 120 Pa·s at the shear rate 10 (1/s), the mixing ratio of PPh:DBE is 0.24 that is PPh:DBE=6:25.

Once the trend line is drawn in advance, the desired viscosity at desired shear rate of the conductive paste can be easily achieved by adjusting the mixing ratio of PPh and DBE according to the trend line. The organic medium is prepared by mixing the organic polymer and the solvent containing PPh and DBE at the adequate mixing ratio for the desired viscosity at the desired shear rate.

By drawing the trend line, it is unnecessary to stock various types of conductive paste having different viscosity at different shear rate. However, the viscosity of the formed conductive paste can be further adjusted by adding a solvent at the finishing fine adjustment because the viscosity could vary due to manufacturing conditions.

The viscosity of the formed conductive paste can be 5 to 500 Pascal second (Pa·s) measured on a viscometer (HBT from Brookfield) using a spindle #14 at 10 rpm at 25° C. in an embodiment. The shear rate can be 1 to 100 (1/s) in an embodiment.

The conductive powder is put into the formed organic medium and mixed well to be dispersed evenly. A mixing tool such as a mixer, a kneader, a two roll mill, a three-roll mill, a ball mill, a beads mill, a sand mill, a high-speed impeller, a homogenizer and combination thereof can be available. To disperse the conductive powder into the organic medium, a mixer followed by a three-roll mill can be one example.

### Conductive Paste Components

The conductive paste can be any type such as non-firing type or firing type, heat curable type or photo-curable type. In any type, the conductive paste comprises (a) a conductive powder, and (b) an organic medium. The conductive powder is dispersed into the organic medium to form a viscous composition called “paste”, having suitable viscosity for applying the paste on a substrate with a desired pattern.

### Conductive Powder

The conductive powder is any powder that can give electrical conductivity to the formed electrode.

The conductive powder can be selected from the group consisting of silver (Ag), copper (Cu), aluminum (Al), nickel (Ni), rhodium (Rh), platinum (Pt), graphite, carbon black and a mixture thereof in an embodiment. The conductive powder can comprise a metal having conductivity of at least 1.00×10⁷ ω⁻¹·m⁻¹ at 293 Kelvin in another embodiment. The conductive powder can comprise a metal selected from the group consisting of Ag, Cu, Al, Ni, Rh, Pt, alloy thereof and a mixture thereof in another embodiment. In another embodiment, conductive powder comprises Ag. These metal powders can be relatively easy to purchase in the market.

The conductive powder is 40 to 95 parts by weight, 52 to 90 parts by weight in another embodiment, 63 to 81 parts by weight in another embodiment.

The conductive powder can be in any shape such as spherical, flaky, or nodular. A mixture of one or more of spherical powder, flaky powder, or nodular powder can be also available. In an embodiment, the conductive powder is flaky in shape. Especially for the non-firing type electrode, the flaky powder could render sufficient conductivity to the formed electrode because the flaky powder has larger contact area of each other in the electrode.

There is no restriction on the particle size of the conductive powder. The particle diameter (D50) can be 0.1 to 10 μm in an embodiment, 1 to 7 μm in another embodiment, 1.5 to 5 μm in another embodiment. The particle diameter (D50) corresponds to 50% of the integrated value of the number of particles when the particle size distribution is prepared. The particle size distribution can be prepared using a commercially available measuring device such as the X100 by Microtrac.

### Organic Medium

The organic medium comprises (i) 2 to 20 parts by weight of an organic polymer; and (ii) 3 to 40 parts by weight of a solvent.

The organic medium is 5 to 60 parts by weight, 10 to 48 parts by weight in another embodiment, 19 to 37 parts by weight in another embodiment.

The organic polymer can comprise any polymer selected from the group consisting of epoxy resin, phenoxy resin, polyester resin, urea resin, melamine resin, silicon resin, polyimide, polyamide, polyurethane, phenoxy resin, acrylic resin, ethyl cellulose and a mixture thereof. In the event of the heat-curable conductive paste, the organic polymer comprises a thermosetting resin such as epoxy resin, melamine resin, polyester resin.

The organic polymer is 3.5 to 14 parts by weight in another embodiment, 4 to 9 parts by weight in another embodiment.

The solvent comprises at least propylene glycol phenyl ether (PPh) and dibasic ester (DBE). A desired viscosity at a desired shear rate can be achieved by adjusting the mixing ratio of PPh and DBE.

PPh can be expressed with the formula below.

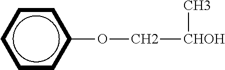

DBE comprise one or more of dimethyl adipate, dimethyl glutarate, or dimethyl succinate, wherein dimethyl succinate is not more than 1 wt % based on the weight of DBE. DBE is two or more of dimethyl adipate, dimethyl glutarate, or dimethyl succinate in another embodiment. DBE contains dimethyl adipate, dimethyl glutarate, and dimethyl succinate in another embodiment. DBE can contain a solvent other than dimethyl adipate, dimethyl glutarate and dimethyl succinate, but not more than 0.5 wt % based on the weight of DBE.

Dimethyl adipate can be expressed with the formula below. Dimethyl adipate is 0.5 to 99.9 wt % in an embodiment, 50 to 95 wt % in another embodiment, 65 to 92 wt % in another embodiment, based on the weight of DBE.

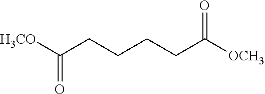 [SMILES: COC(=O)CCCCC(=O)OC]

Dimethyl glutarate can be expressed with the formula below. Dimethyl glutarate is 0.01 to 99.5 wt % in an embodiment, in an embodiment, 1 to 65 wt % in another embodiment, 5 to 15 wt % in another embodiment, based on the weight of DBE.

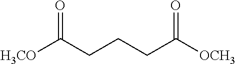 [SMILES: COC(=O)CCCC(=O)OC]

Dimethyl succinate can be expressed with the formula below. Dimethyl succinate is 0.01 to 1 wt % based on the weight of DBE in an embodiment.

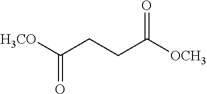

“DBE-2”, “DBE-3”, “DBE-5”, or “DBE-6” purchasable from INVISTA Inc. can be available as DBE.

The mixing ratio of PPh and DBE can be determined explained above. The mixing ratio of PPh and DBE can be in a range of 1:15 to 4:1 in an embodiment, 1:5 to 2:1 in another embodiment. With the mixing ratio, an electrode with a fine pattern or an electrode with surface flat and smooth can be formed.

The solvent can be 8 to 31 parts by weight in another embodiment, 11 to 25 parts by weight in another embodiment.

Besides the conductive powder and the organic medium, the conductive paste can further comprise an additive such as thickener, stabilizer, viscosity modifier, oxidation inhibitor or inorganic powder. In the event of the photo-curable conductive paste, the paste further comprises a photo-polymerization compound and photo-polymerization initiator. Amount of the additive depends on a desired characteristic of the resulting paste can be chosen by people in the field.

In an embodiment, the conductive paste can further comprise 0.01 to 3 parts by weight of the inorganic powder as a black pigment.

The conductive paste can still further comprise 1 to 15 parts by weight of a glass frit when the conductive paste is firing type that is fired at high temperature for example 450 to 1000° C. to form an electrode. The glass frit melts and adheres to the substrate during the firing.

### Method of Manufacturing an Electrode

The method of manufacturing the electrode using the conductive paste is explained here.

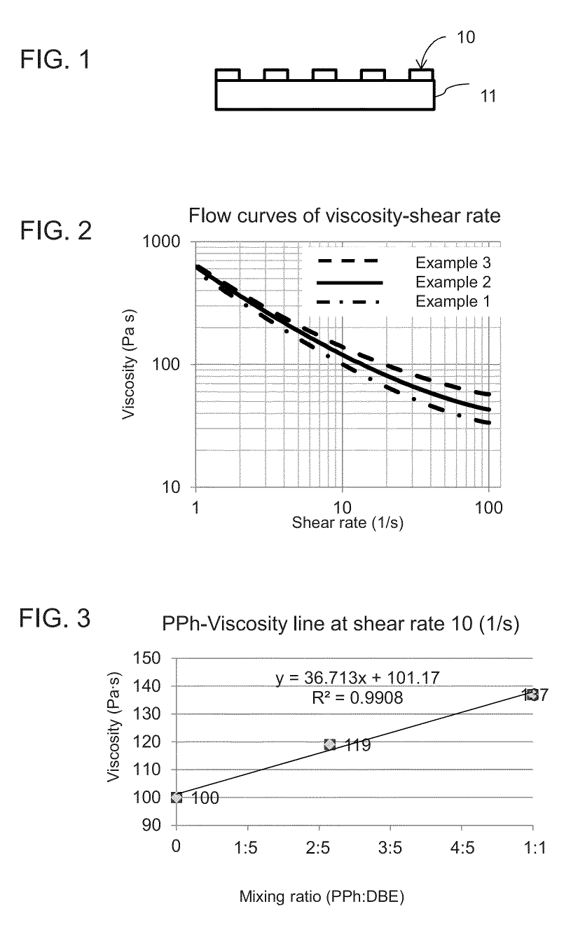

The method of manufacturing an electrode comprises steps of applying onto a substrate the conductive paste, and heating the applied conductive paste at 80 to 1000° C. The method is described below along with FIG. 1.

The conductive paste 10 is applied onto a substrate 11. There is no restriction on the substrate 11. The substrate 11 can be a polymer film, a glass substrate, ceramic substrate, or semiconductor substrate in an embodiment.

The conductive paste 10 is applied onto the substrate 11 by screen printing, stencil printing, spin coating, blade coating or nozzle discharge in an embodiment. The conductive paste 10 is applied by the screen printing that can form any pattern, even a complicated pattern, in a short time by using a screen mask in an embodiment.

The conductive paste can be applied in a desired pattern for example fine line or high aspect ratio when the conductive paste has proper viscosity at a given shear rate. Therefore, controlling viscosity of the conductive paste is advantageous to easily form an electrode with the desired pattern.

Next, the applied paste 10 on the substrate 11 is heated at 60 to 1000° C. When the conductive paste is non-firing type, the heat temperature can be 60 to 350° C. in another embodiment, 100 to 280° C. in another embodiment.

In the event that the conductive paste is firing type, the heating temperature is 450 to 1000° C. in another embodiment, 520 to 800° C. in another embodiment. The conductive powder could sinter and the organic medium would be burned off during the heating step.

The formed electrode after heating could have a pattern of 1 to 1000 μm of width and 1 to 20 μm, of thickness in an embodiment, 1 to 300 μm of width and 1 to 15 μm of thickness in another embodiment, 1 to 80 μm of width and 1 to 10 μm of thickness in another embodiment. Such width and thickness can be required especially for a down-sized electrical device.

The electrical conductivity of the formed electrode is 1.0×10⁴ to 1.0×10⁸ Ω⁻¹·m⁻¹ at 293 Kelvin in an embodiment.

The electrode manufactured by the method can be used in any electrical devices, for example, a solar cell, a touch-panel, a plasma display panel or a LED module that contain an electrode formed by a conductive paste.

### EXAMPLE

The present invention is illustrated by, but is not limited to, the following examples.

The organic polymer of a mixture of 5.2 parts by weight of phenoxy resin (PKFE™, Inchem) and 1.3 parts by weight of epoxy resin (Epotohto YD020G from Nippon Steel Chemical Co., Ltd.) was dissolved in a solvent to make the organic medium. The solvent was a mixture of PPh (Dowanol™ from Dow Chemical Company) and DBE (DBE-3 from INVISTA Inc.). DBE contained 89 wt % of dimethyl adipate, 10 wt % of dimethyl glutarate, and 0.2 wt % of dimethyl succinate, the rest of methanol and water based on the weight of DBE.

The flaky silver powder with D50 of 2.0 μm and carbon black powder as a black pigment were added to the organic medium to mix well by a mixer followed by a three-roll mill. The mixture resulted in the conductive paste having viscosity of 250 Pa·s Brookfield HBT with a spindle #14.

The amounts of the components are shown respectively in Table 1 as “parts by weight”.

TABLE 1

| Composition (parts by weight) | Example 1 | Example 2 | Example 3 |
|---|---|---|---|
| Ag flaky powder | 75 | 75 | 75 |
| Organic polymer | 6.5 | 6.5 | 6.5 |
| Carbon black powder | 0.5 | 0.5 | 0.5 |
| Solvent | 18 | 18 | 18 |
| Mixing weight ratio of | 0:18 | 5:13 | 1:1 |
| PPh and DBE-3 | | | |

Viscosity was measured by using a rheometer (HAAKE MARS III from Thermo Fisher Scientific Inc.). The shear rate gradually rose from 0.1 to 100 (1/s), and then lowered back from 100 to 0.1 (1/s) for 60 seconds. The viscosity was continuously measured at 25° C. as the shear rate lowered. The flow curves of viscosity-shear rate and the trend line explained above were drawn as illustrated in FIG. 2 and FIG. 3.

What is claimed is:

1. A method of manufacturing a conductive paste comprising steps of:
(a) preparing 5 to 60 parts by weight of an organic medium comprising,
(i) 2 to 20 parts by weight of an organic polymer; and
(ii) 3 to 40 parts by weight of a solvent comprising propylene glycol phenyl ether (PPh) and a dibasic ester (DBE) comprising one or more of dimethyl adipate, dimethyl glutarate or dimethyl succinate, wherein dimethyl succinate is not more than 1 wt % based on the weight of DBE, and wherein the mixing ratio of PPh and DBE is determined according to a desired viscosity at a desired shear rate, and
(b) dispersing 40 to 95 parts by weight of a conductive powder into the organic medium.

2. The method of claim 1, wherein the conductive paste further comprises 0.01 to 3 parts by weight of a black pigment.

3. The method of claim 1, wherein the conductive powder is flaky in shape.

4. A method of manufacturing an electrode comprises steps of:
applying the conductive paste manufactured by the method of claim 1 onto a substrate; and
heating the applied conductive paste on the substrate at 60 to 1000° C.

5. The method of claim 4, wherein the conductive paste is applied onto the substrate by screen printing, stencil printing, spin coating, blade coating or nozzle discharge.

6. The method of claim 5, wherein the formed electrode has pattern of width 30 to 1000 μm of width and 1 to 20 μm of thickness.

7. An electrical device comprising an electrode manufactured with the conductive paste of claim 1.

8. The device of claim 7 is a touch panel.

9. A method of manufacturing a conductive paste comprising steps of:
(a) creating a trend line regarding mixing ratio of two different solvents and viscosity at a desired shear rate in a conductive paste comprising the solvents;
(b) determining a desired viscosity in the conductive paste;
(c) determining a mixing ratio of the two different solvents based on the trend line and the desired viscosity so that actual viscosity of the paste composition will be around the desired viscosity at the desired shear rate;
(d) preparing 5 to 60 parts by weight of an organic medium comprising,
(i) 2 to 20 parts by weight of an organic polymer; and
(ii) 3 to 40 parts by weight of the solvents; and
(e) dispersing 40 to 95 parts by weight of a conductive powder into the organic medium.

10. A method of claim 9, wherein the solvents comprise propylene glycol phenyl ether (PPh) and a dibasic ester (DBE) comprising one or more of dimethyl adipate, dimethyl glutarate or dimethyl succinate, wherein dimethyl succinate is not more than 1 wt % based on the weight of DBE.

11. The method of claim 9, wherein the conductive paste further comprises 0.01 to 3 parts by weight of a black pigment.

12. The method of claim 9, wherein the conductive powder is flaky in shape.
